(19) United States
(12) Patent Application Publication
(10) Pub. No.: US 2016/0324609 A1
(43) Pub. Date: Nov. 10, 2016

(54) TOOTHBRUSH HEAD FOR ELECTRIC TOOTHBRUSH

(71) Applicant: SAKE CO., LTD., Seosan-si (KR)

(72) Inventor: Jin Won HO, Goyang-si (KR)

(21) Appl. No.: 15/109,372

(22) PCT Filed: Jan. 6, 2015
(86) PCT No.: PCT/KR2015/000077

§ 371 Date: Jun. 30, 2016

(30) Foreign Application Priority Data
Jan. 8, 2014 (KR) 10-2014-0002533

(51) Int. Cl. A61C 17/26; A46B 9/04; A61C 17/22

(52) U.S. Cl. CPC A61C 17/26; A61C 17/222; A46B 9/04

(57) ABSTRACT

The present invention relates to a toothbrush head which is constituted by a body, a first rotation pipe, a drive unit, a support, a rotator, and an auxiliary rotator and can clearly wash every nook and corner of teeth and wash upper teeth and lower teeth at once only by a method that just slightly bits a part of a body unlike the existing tooth brushing method in which a user brushes his/her teeth by rapidly moving his/her hand left and right and up and down and right to reduce a tooth brushing time. As a correct washing method of the teeth, only when the teeth are brushed while rotating a toothbrush vertically from an upper side to a lower side of the teeth, food wastes can be easily removed and an injury of gum parts connected with the teeth due to wrong tooth brushing (tooth brushing performed in a horizontal direction of a set of teeth) can be prevented and the present invention is configured to be suitable for the tooth brushing.

### TECHNICAL FIELD

The present invention relates to a toothbrush head for an electric toothbrush.

### BACKGROUND ART

In general, a toothbrush for brushing teeth has a form in which a plurality of toothbrush hairs are implanted in a head connected with a handle. Since the toothbrush is implemented in a simple structure, the toothbrush has been used for a long time. However, since the toothbrush is difficult to effectively remove food wastes stuck in a gap between teeth, there are a lot of cases in which a cavity is generated even though tooth brushing is performed periodically (three times a day and 3 minutes every time) and moreover, there are even a lot of cases in which the toothbrush makes a wound to gums.

In order to solve the problem, an electric toothbrush has been developed and used, which can brush the teeth by rotating a disc-shaped head in which the toothbrush hairs are implanted in left and right directions.

However, the electric toothbrush can also cleanly brush the surface of the teeth, but the electric toothbrush is still difficult to effectively remove the food wastes in a gap direction of the teeth or wastes of inner surfaces of the teeth and further, since the head is very small, there is a problem in that a lot of time is required for the tooth brushing. In addition, the electric toothbrush has a problem in that it is not easy to accurately brush the teeth according to a correct direction due to a mouth shape and a structure of the teeth of the user.

### SUMMARY OF INVENTION

### Technical Problem

The present invention is contrived to solve the problem and an object of the present invention is to provide a toothbrush head for an electric toothbrush which can cleanly remove food wastes stuck on inner surfaces and the surface of teeth and in a gap of teeth and reduce a tooth brushing time.

### Solution to Problem

In order to achieve the object, the present invention provides a toothbrush head for an electric toothbrush combined to one end of a body including a power supply unit and a motor embedded therein and washing teeth with motive power of the body transferred by an operation of a user, including: a body as a hollow bar-shaped member in which one end is combined to one end of the body and a first through-hole penetrating both sides of the other end is formed; a first rotation pipe having a circular pipe shape and installed in the first through-hole; a drive unit as a component installed in the body in which one end is installed on one end of the body and the motive power transferred from the body is transferred to the first rotation pipe to rotate the first rotation pipe; a support as a bar-shaped member in which a second through-hole is formed on one end, in which the other end is combined with one side of the other end of the body and two supports are combined with each of the top and the bottom of the body so that the other end is combined in an ‘X’ shape around the first through-hole; a rotator as a roller-type member in which a plurality of toothbrush hairs is combined with the outer periphery, in which one end is inserted and installed in the first rotation pipe; and an auxiliary rotator as the roller-type member in which the plurality of toothbrush hairs is combined with the outer periphery, in which one end is inserted and installed in the second rotation pipe, wherein as the first rotation pipe rotates by the motive power of the body, the rotator rotates and when the rotator rotates, the auxiliary rotator rotates together with the rotator while the toothbrush hairs of the rotator and the toothbrush hairs of the auxiliary rotator hit each other.

Further, the present invention provides the toothbrush head for an electric toothbrush in which a drive shaft of which one end is installed on one end of the body to receive the motive power transferred from the body, worm gear fastened to the other end of the drive shaft to receive the motive power of the drive shaft, a worm wheel engaged with the worm gear to receive the motive power of the worm gear, and a first drive band connecting the first rotation pipe with both sides or one side of the worm wheel.

In addition, the present invention provides the toothbrush head for an electric toothbrush, further including: a second rotation pipe having the circular pipe shape and installed in the second through-hole; and a second drive band connecting the first rotation pipe and the second rotation pipe to transfer rotational force of the first rotation pipe to the second rotation pipe, wherein one end of the auxiliary rotator is installed in the second rotation pipe, and as the first rotation pipe rotates by the motive power of the body, the rotator rotates and as the second rotation pipe rotates along with the first rotation pipe, the auxiliary rotator rotates, when the rotator rotates, the auxiliary rotator rotates together with the rotator while the toothbrush hairs of the rotator and the toothbrush hairs of the auxiliary rotator hit each other.

Moreover, the present invention provides the toothbrush head for an electric toothbrush, further including a buffer member installed between the supports installed on the top and the bottom of the other end of the body.

Besides, the present invention provides the toothbrush head for an electric toothbrush, further including a cover as a plate-shaped member installed on one side of the body blocking a foreign material such as toothpaste or saliva discharged out of a mouse when a user brushes his/her teeth.

Further, the present invention provides the toothbrush head for an electric toothbrush in which the cover is formed to have a curve shape toward the other end of the body.

### Advantageous Effects of Invention

The present invention having the above configuration provides effects described below.

First, according to the present invention, toothbrush hairs simultaneously rotate, which are installed on four rotational shafts positioned at upper and lower and left and right sides by toothbrush hairs installed on one drive shaft to cleanly remove food wastes stuck in a gap of teeth. That is, according to the present invention, the toothbrush hairs installed on the rotational shafts rotate clockwise or counterclockwise to cleanly wash the teeth and the gap between the teeth.

Second, according to the present invention, since inner surfaces and the surface of upper teeth and lower teeth can be washed at once, a tooth brushing time can be reduced. That is, according to the present invention, since the teeth can be washed by five rotators at once, when a user just changes only a position of a toothbrush head according to a set of teeth without brushing the teeth by moving busily, the teeth can be easily washed.

### BRIEF DESCRIPTION OF DRAWINGS

FIG. 1 is a perspective view illustrating combination of a toothbrush head and a body according to the present invention.

FIG. 2 is an exploded perspective view illustrating an embodiment of the toothbrush head according to the present invention.

FIG. 3 is a perspective view illustrating a state in which a first rotation pipe and a support are combined with the body according to the present invention.

FIG. 4 is a side view illustrating a state in which a buffer member is coupled to FIG. 3.

FIG. 5 is an exploded perspective view illustrating a second embodiment of the toothbrush head according to the present invention.

FIG. 6 is a diagram illustrating an operating principle of the toothbrush head according to the present invention.

FIG. 7 is a diagram illustrating a strength of tooth brushing according to an angle of the toothbrush head while the tooth brushing.

FIG. 8 is a diagram illustrating a state in which a user brushes his/her teeth.

FIG. 9 is a cross-sectional view illustrating the state in which the user brushes his/her teeth.

FIG. 10 is another cross-sectional view illustrating the state in which the user brushes his/her teeth.

### REFERENCE SIGNS LIST

10: Toothbrush head
20: Body
100: Body
110: First through-hole
200: First rotation pipe
210: Second rotation pipe
300: Drive unit
310: Drive shaft
320: Worm gear
330: Worm wheel
340: First drive band
350: Second drive band
400: Support
410: Second through-hole
500: Rotator
550: Auxiliary rotator
600: Buffer member
700: Cover

### DESCRIPTION OF EMBODIMENTS

Hereinafter, detailed contents of a toothbrush head for an electric toothbrush according to the present invention will be described in detail with reference to the accompanying drawings.

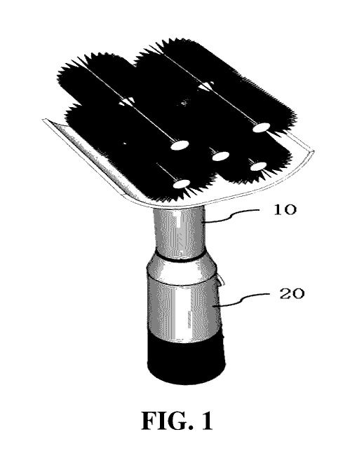

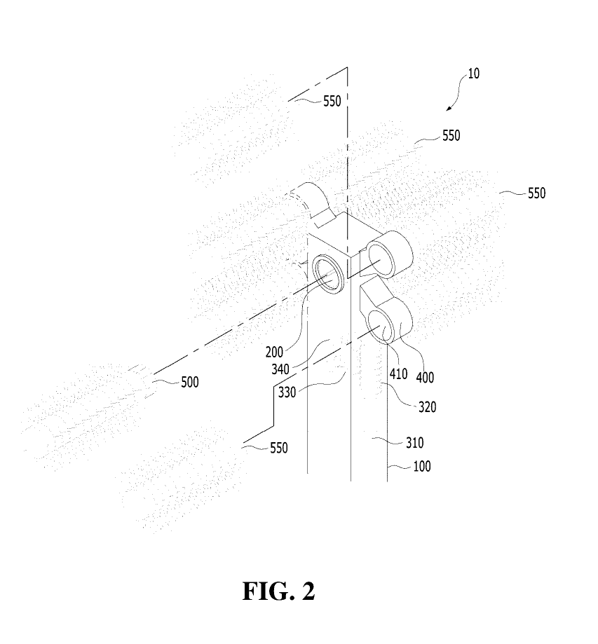

FIG. 1 is a perspective view illustrating combination of a toothbrush head and a body according to the present invention and FIG. 2 is an exploded perspective view illustrating an embodiment of the toothbrush head according to the present invention.

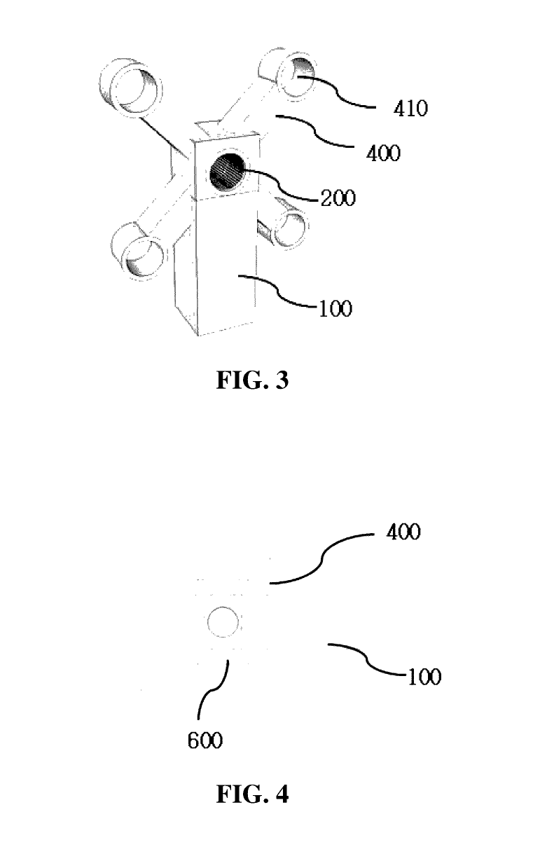

FIG. 3 is a perspective view illustrating a state in which a first rotation pipe and a support are combined with the body according to the present invention and FIG. 4 is a side view illustrating a state in which a buffer member is coupled to FIG. 3.

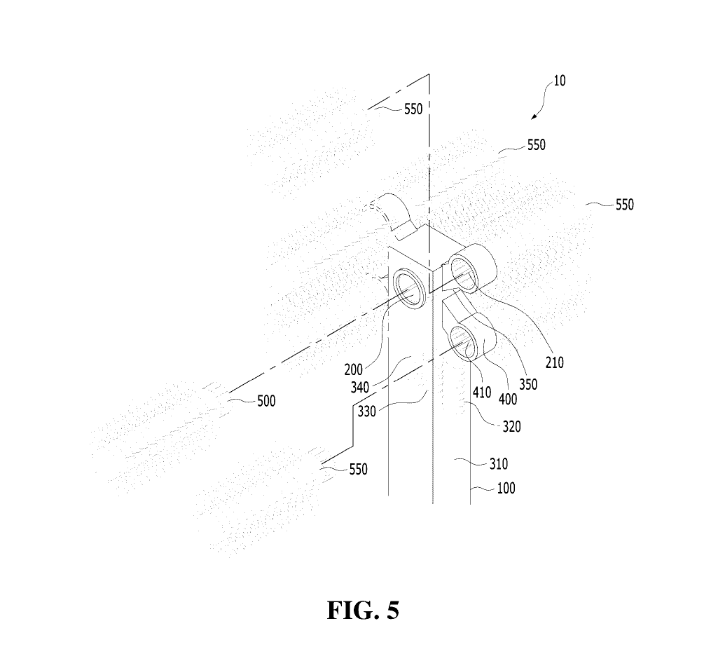

FIG. 5 is an exploded perspective view illustrating a second embodiment of the toothbrush head according to the present invention.

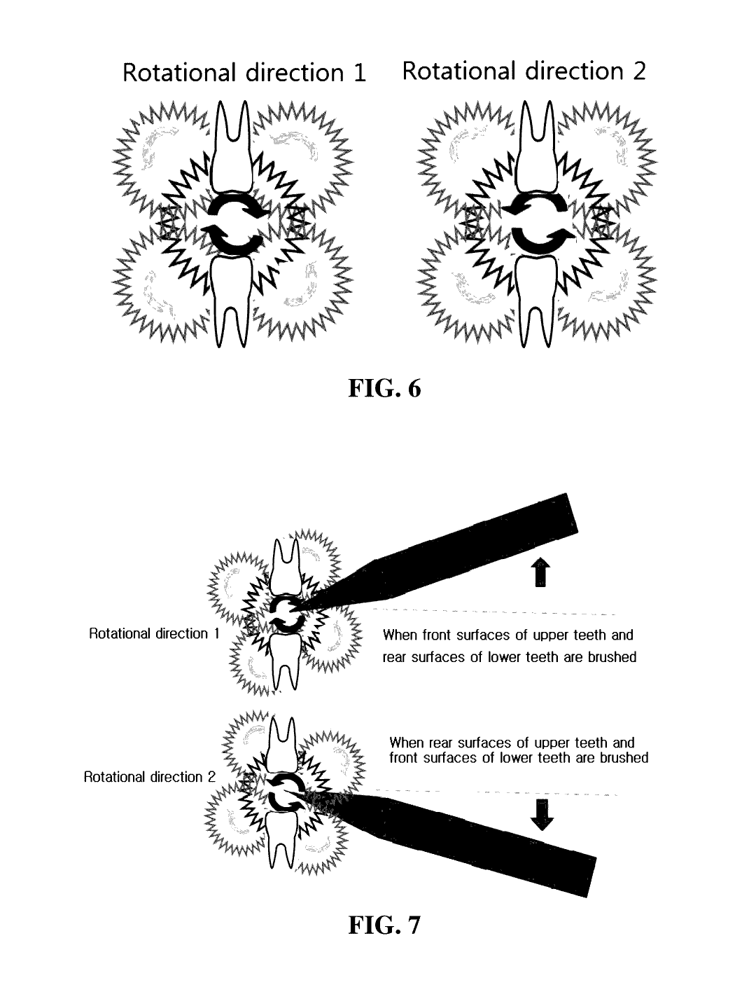

FIG. 6 is a diagram illustrating an operating principle of the toothbrush head according to the present invention and FIG. 7 is a diagram illustrating a strength of tooth brushing according to an angle of the toothbrush head while the tooth brushing.

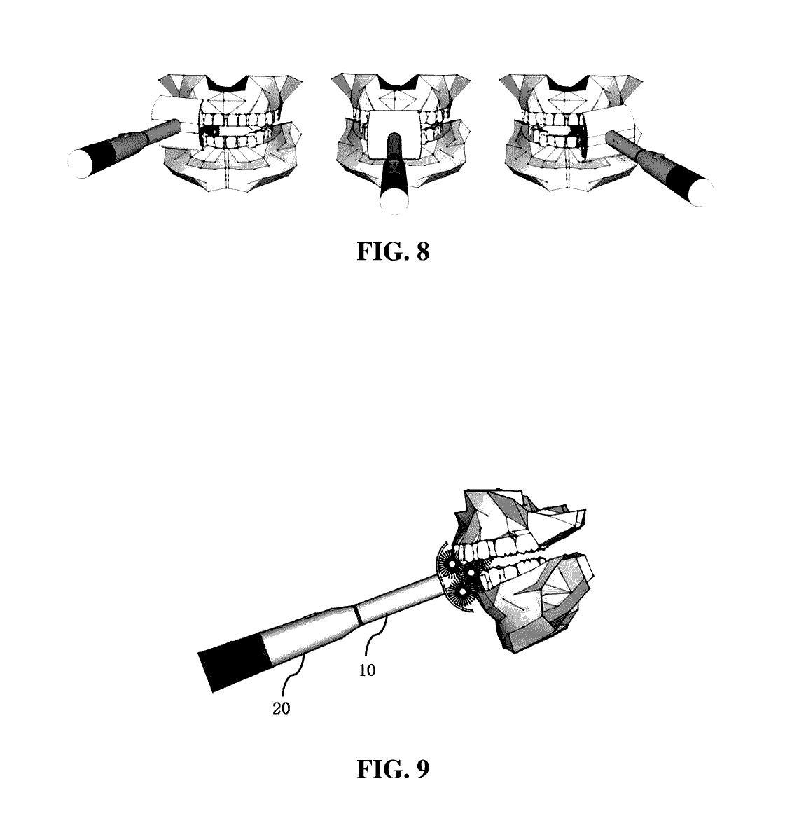

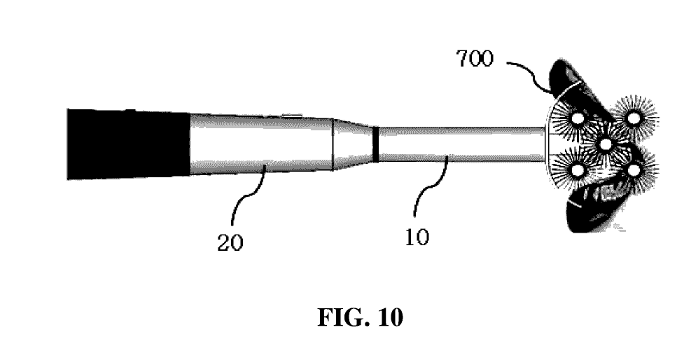

FIG. 8 is a diagram illustrating a state in which a user brushes his/her teeth and FIG. 9 is a cross-sectional view illustrating the state in which the user brushes his/her teeth. FIG. 10 is another cross-sectional view illustrating the state in which the user brushes his/her teeth. p The present invention relates to a toothbrush head 10 for an electric toothbrush and in detail, a toothbrush head for an electric toothbrush combined to one end of a body including a power supply unit and a motor embedded therein and washing teeth with motive power of the body transferred by an operation of a user, includes: a body 100 as a hollow bar-shaped member in which one end is combined to one end of the body 20 and a first through-hole 110 penetrating both sides of the other end is formed; a first rotation pipe 200 having a circular pipe shape and installed in the first through-hole 110; a drive unit 300 as a component installed in the body 100 in which one end is installed on one end of the body 100 and the motive power transferred from the body 20 is transferred to the first rotation pipe 200 to rotate the first rotation pipe 200; a support 400 as a bar-shaped member in which a second through-hole 410 is formed on one end, in which the other end is combined with one side of the other end of the body 100 and two supports are combined with each of the top and the bottom of the body 100 so that the other end is combined in an ‘X’ shape around the first through-hole 110; a rotator 500 as a roller-type member in which a plurality of toothbrush hairs is combined with the outer periphery, in which one end is inserted and installed in the first rotation pipe 200; and an auxiliary rotator 550 as the roller-type member in which the plurality of toothbrush hairs is combined with the outer periphery, in which one end is inserted and installed in the second rotation pipe 410, wherein as the first rotation pipe 200 rotates by the motive power of the body 20, the rotator 500 rotates and when the rotator 500 rotates, the auxiliary rotator 550 rotates together with the rotator 500 while the toothbrush hairs of the rotator 500 and the toothbrush hairs of the auxiliary rotator 550 hit each other.

As illustrated in FIG. 2, the present invention relates to a toothbrush head 10 which is constituted by the body 100, the first rotation pipe 200, the drive unit 300, the support 400, the rotator 500, and the auxiliary rotator 550 and can clearly wash every nook and corner of teeth and wash upper teeth and lower teeth at once only by a method that just slightly bits a part of the body 100 unlike the existing tooth brushing method in which a user brushes his/her teeth by rapidly moving his/her hand left and right and up and down and right to reduce a tooth brushing time. As a correct washing method of the teeth, only when the teeth are brushed while rotating a toothbrush vertically from an upper side to a lower side of the teeth, food wastes can be easily removed and an injury of gum parts connected with the teeth due to wrong tooth brushing (tooth brushing performed in a horizontal direction of a set of teeth) can be prevented and the present invention is configured to be suitable for the tooth brushing.

In general, a toothbrush for brushing teeth has a form in which a plurality of toothbrush hairs are implanted in a head connected with a handle. Since the toothbrush is implemented in a simple structure, the toothbrush has been used for a long time. However, since the toothbrush is difficult to effectively remove food wastes stuck in a gap between teeth, there are a lot of cases in which a cavity is generated even though tooth brushing is performed periodically (three times a day and 3 minutes every time) and moreover, there are even a lot of cases in which the toothbrush makes a wound to gums.

In order to solve the problem, an electric toothbrush has been developed and used, which can brush the teeth by rotating a disc-shaped head in which the toothbrush hairs are implanted in left and right directions.

However, the electric toothbrush can also cleanly brush the surface of the teeth, but the electric toothbrush is still difficult to effectively remove the food wastes in a gap direction of the teeth or wastes of inner surfaces of the teeth and further, since the head is very small, there is a problem in that a lot of time is required for the tooth brushing. In addition, the electric toothbrush has a problem in that it is not easy to accurately brush the teeth according to a correct direction due to a mouth shape and a structure of the teeth of the user.

The preset invention is contrived to solve the problem and an object of the present invention is to provide a toothbrush head for an electric toothbrush which can cleanly remove food wastes stuck on inner surfaces and the surface of teeth and in a gap of the teeth, that is, toothbrush hairs simultaneously rotate, which are installed on four rotational shafts positioned at upper and lower and left and right sides by toothbrush hairs installed on one drive shaft to cleanly remove food wastes stuck in a gap of teeth. That is, according to the present invention, the toothbrush hairs installed on the rotational shafts rotate clockwise or counterclockwise to cleanly wash the teeth and the gap between the teeth. Further, the present invention has an advantage in that since inner surfaces and the surface of upper teeth and lower teeth can be washed at once, a tooth brushing time can be reduced. That is, the present invention has an advantage in that since the teeth can be washed by five rotators at once, when a user just changes only a position of a toothbrush head according to a set of teeth without brushing the teeth by moving busily, the teeth can be easily washed.

The body 100 as a hollow bar-shaped member is a member in which one end is combined to one end of the body 20 and a first through-hole 110 penetrating both sides of the other end is formed. The body 100 serves as a frame of the toothbrush head 100 and when the toothbrush head 10 is conveniently inserted into a mouse of the user in tooth brushing and a required strength is satisfied, a cross-section of the body 100 may be manufactured in various shapes including a quadrangular shape, a circular shape, and the like.

The first rotation pipe 200 is a member having a circular pipe shape and installed to rotate by receiving rotational force through the first through-hole 110. The first rotation pipe 200 is a component that is installed in the body 100 to rotate by receiving the rotational force of the drive unit 300 to be described below and a protrusion may protrude on the inner surface of the first rotation pipe 200 so that the rotator 500 is easily combined with the inner surface of the first rotation pipe 200.

The drive unit 300 as a component installed in the body 100 is a component in which one end is installed on one end of the body 100 and the motive power transferred from the body 20 is transferred to the first rotation pipe 200 to rotate the first rotation pipe 200. The drive unit 300 is a component that receives the rotational force generated by a motor installed in the body 20 and rotates the first rotation pipe 200. When the driving unit 300 may transfer the rotational force generated from the body 20 to the first rotation pipe 200, the driving unit 300 may be configured in various constitutions. Further, the drive unit 300 may be manufactured on one end of the body 100 according to various shapes of the electric toothbrush.

As one example, the drive unit 300 is constituted by a drive shaft, a worm gear, a worm wheel, and a first drive band to transfer the rotational force generated from the body 20 to the first rotation pipe 200 and rotate the first rotation pipe 200 at a desired speed. The drive shaft 310 is a component that is installed on one end of the body 100 and receives the motive power transferred from the body 20. The drive shaft which is installed inside one end of the body 100 may be manufactured so as to engage with the bodies 20 of various types of electric toothbrushes so that one end is universally used and limitatively manufactured so as to engage with the body 20 of a predetermined type of electric toothbrush.

The worm gear 320 is a member that is fastened to the other end of the drive shaft 310 to receive the motive power of the drive shaft 310. The worm gear is a general gear used in industries that transfer the motive power such as the electric toothbrush, and the like. The worm wheel 330 is a member that engages with the worm gear 320 to receive the motive power of the worm gear 320. The worm wheel may be installed at one side of the inside of the body 100 so as to engage with the worm gear. As one example, since protrusions that protrude at both sides of the worm wheel are rotatably combined in the body 100, as the worm gear rotates, the worm wheel may easily rotate. The worm wheel is the general gear used in the industries that transfer the motive power such as the electric toothbrush, and the like. The first drive band 340 is a member that connects the first rotation pipe 200 with both sides or one side of the worm wheel 330. The first drive band is a member having a circular band shape, which connects the protrusions which protrude at both sides and the first rotation pipe 200 to each other.

The support 400 as a bar-shaped member in which the second through-hole 410 is formed on one end, in which the other end is combined with one side of the other end of the body 100 and two supports are combined with each of the top and the bottom of the body 100 so that the other end is combined in an ‘X’ shape around the first through-hole 110. The support 400 as a component in which the auxiliary rotator 550 is installed is installed on one side of the body 100 so that the toothbrush hairs of the auxiliary rotator 550 and the toothbrush hairs of the rotator 500 engage with each other. The inner surface of the second through-hole 410 is manufactured so that friction little occurs when the auxiliary rotator 550 rotate. When the support 400 may have a required strength and play a required role, the support 400 may be manufactured in various shapes.

The rotator 500 as a roller-type member in which a plurality of toothbrush hairs is combined with the outer periphery is a member in which one end is inserted and installed in the first rotation pipe 200. In the rotator 500, one end of the roller-type member is inserted into each of both ends of the first rotation pipe 200 and the respective one ends may be combined with each other and two roller-type members are integrally molded and inserted into the first rotation pipe 200 to be installed. The rotator 500 is a component in which the plurality of toothbrush hairs is combined with the outer periphery and when the teeth are safely brushed by the required strength, the rotator 500 may be manufactured in various shapes.

The auxiliary rotator 550 as the roller-type member is a component in which the plurality of toothbrush hairs is combined with the outer periphery, in which one end is inserted and installed in the second through-hole 410. The auxiliary rotator 550 is a component that rotates together with the rotator 500 and in detail, as the first rotation pipe 200 rotates by the motive power of the body 20, the rotator 500 rotates and when the rotator 500 rotates, the auxiliary rotator 550 rotates together with the rotator 500 while the toothbrush hairs of the rotator 500 and the toothbrush hairs of the auxiliary rotator 550 hit each other. That is, the auxiliary rotator 550 is a component that is installed so that the toothbrush hairs engage with the rotator 500 to rotate together when the rotator 500 rotates. In the rotator 550, one end of the roller-type member is inserted into each of both ends of the second through-hole 410 and the respective one ends may be combined with each other and two roller-type members are integrally molded and inserted into the second through-hole 410 to be installed. The auxiliary rotator 550 is a component in which the plurality of toothbrush hairs is combined with the outer periphery and when the teeth are safely brushed by the required strength, the rotator 500 may be manufactured in various shapes.

According to the preset invention, as illustrated in FIG. 5, the toothbrush head for an electric toothbrush may further include: a second rotation pipe 210 having the circular pipe shape and installed in the second through-hole 410; and a second drive band 350 connecting the first rotation pipe 200 and the second rotation pipe 210 to transfer rotational force of the first rotation pipe 200 to the second rotation pipe 210, wherein one end of the auxiliary rotator 550 is installed in the second rotation pipe 210, and as the first rotation pipe 200 rotates by the motive power of the body 20, the rotator 500 rotates and as the second rotation pipe 210 rotates along with the first rotation pipe 200, the auxiliary rotator 550 rotates, when the rotator 500 rotates, the auxiliary rotator 550 rotates together with the rotator 500 while the toothbrush hairs of the rotator 500 and the toothbrush hairs of the auxiliary rotator 550 hit each other.

The second rotation pipe 210 is a member having the circular pipe shape like the first rotation pipe 200 and installed to rotate by receiving the rotational force through the second through-hole 410. The second rotation pipe 210 is a component which is connected with the first rotation pipe 200 through the second drive band 350 to rotate together when the first rotation pipe 200 rotates and the protrusion may protrude on the inner surface of the second rotation pipe so that the auxiliary rotator 550 is easily combined with the inner surface. The second drive band 350 is a component that plays the same role as the first drive band 340.

According to the preset invention, as illustrated in FIG. 4, the toothbrush head for an electric toothbrush may further include a buffer member 600 installed between the supports 400 installed on the top and the bottom of the other end of the body 100. The buffer member 600 is a component installed at a location where the teeth contact each other when the body 100 is inserted into the mouse in order for the user to safely brush the teeth at the time of brushing the teeth. When the buffer member 600 may protect the teeth at the time of brushing the teeth, the buffer member 600 may be installed by various materials, but the buffer member 600 is generally made of a rubber material in order to absorb shock.

Further, according to the present invention, as illustrated in FIG. 10, the toothbrush head for an electric toothbrush may be configured to further include a cover 700 as a plate-shaped member installed on one side of the body 100 blocking a foreign material such as toothpaste or saliva discharged out of a mouse when a user brushes his/her teeth. The cover 700 is a component for preventing clothes of the user, and the like from being foul with various foreign materials which come out of the mouse at the time of brushing the teeth. When the cover 700 is installed in the body 100 to prevent the foreign materials in the mouse, the cover 700 may be manufactured in various shapes. As one example, the cover 700 is formed to have a curve shape toward the other end of the body 100. When the cover 700 has the curve shape, both ends of the cover 700 are positioned at lips and the auxiliary rotator 550 which rotates does not thus contact the lips to prevent the lips from being wound. When the cover 700 may have the required strength and play the above role, the cover 700 may be manufactured with various materials and in various shapes.

Although a preferred embodiment of the toothbrush head for the electric toothbrush according to the present invention has been described, the preferred embodiment is described as at least one embodiment and since the technical spirit and a configuration and an action of the present invention are not limited thereto, the scope of the technical spirit of the present invention is not restricted/limited by drawings or description referring to the drawings. Further, a concept and an embodiment of the invention presented in the present invention may be used by those skilled in the art as a basis for modification or design in another structure and an equivalent structure modified or changed by those skilled in the art is included in the technical scope of the present invention described in the appended claims and various changes, substitutions, and modifications of the equivalent structure can be made within a limit without departing from the spirit or the scope of the present invention described in the appended claims.

1. A toothbrush head for an electric toothbrush combined to one end of a body including a power supply unit and a motor embedded therein and washing teeth with motive power of the body transferred by an operation of a user, comprising:
a body (100) as a hollow bar-shaped member in which one end is combined to one end of the body (20) and a first through-hole (110) penetrating both sides of the other end is formed;
a first rotation pipe (200) having a circular pipe shape and installed in the first through-hole (110);
a drive unit (300) as a component installed in the body (100) in which one end is installed on one end of the body (100) and the motive power transferred from the body (20) is transferred to the first rotation pipe (200) to rotate the first rotation pipe (200);
a support (400) as a bar-shaped member in which a second through-hole (410) is formed on one end, in which the other end is combined with one side of the other end of the body (100) and two supports are combined with each of the top and the bottom of the body (100) so that the other end is combined in an ‘X’ shape around the first through-hole (110);
a rotator (500) as a roller-type member in which a plurality of toothbrush hairs is combined with the outer periphery, in which one end is inserted and installed in the first rotation pipe (200); and
an auxiliary rotator (550) as the roller-type member in which the plurality of toothbrush hairs is combined with the outer periphery, in which one end is inserted and installed in the second through-hole (410),
wherein as the first rotation pipe (200) rotates by the motive power of the body (20), the rotator (500) rotates and when the rotator (500) rotates, the auxiliary rotator (550) rotates together with the rotator (500) while the toothbrush hairs of the rotator (500) and the toothbrush hairs of the auxiliary rotator (550) hit each other.

2. The toothbrush head for an electric toothbrush of claim 1, wherein the drive unit (300) includes a drive shaft (310) of which one end is installed on one end of the body (100) to receive the motive power transferred from the body (20), worm gear (320) fastened to the other end of the drive shaft (310) to receive the motive power of the drive shaft (310), a worm wheel (330) engaged with the worm gear (320) to receive the motive power of the worm gear (320), and a first drive band (340) connecting the first rotation pipe (200) with both sides or one side of the worm wheel (330).

3. The toothbrush head for an electric toothbrush of claim 1, further comprising:
a second rotation pipe (210) having the circular pipe shape and installed in the second through-hole (410); and
a second drive band (350) connecting the first rotation pipe (200) and the second rotation pipe (210) to transfer rotational force of the first rotation pipe (200) to the second rotation pipe (210),
wherein one end of the auxiliary rotator (550) is installed in the second rotation pipe (210), and
as the first rotation pipe (200) rotates by the motive power of the body (20), the rotator (500) rotates and as the second rotation pipe (210) rotates along with the first rotation pipe (200), the auxiliary rotator (550) rotates, and when the rotator (500) rotates, the auxiliary rotator (550) rotates together with the rotator (500) while the toothbrush hairs of the rotator (500) and the toothbrush hairs of the auxiliary rotator (550) hit each other.

4. The toothbrush head for an electric toothbrush of claim 1, further comprising:
a buffer member (600) installed between the supports (400) installed on the top and the bottom of the other end of the body (100).

5. The toothbrush head for an electric toothbrush of claim 1, further comprising:
a cover (700) as a plate-shaped member installed on one side of the body (100) blocking a foreign material such as toothpaste or saliva discharged out of a mouse when a user brushes his/her teeth.

6. The toothbrush head for an electric toothbrush of claim 5, wherein the cover (700) is formed to have a curve shape toward the other end of the body (100).
